(19) United States
(12) Patent Application Publication
(10) Pub. No.: US 2016/0380853 A1
(43) Pub. Date: Dec. 29, 2016

(54) REPORTING MEDIA CONSUMPTION BASED ON SERVICE AREA

(71) Applicant: QUALCOMM Incorporated, San Diego, CA (US)

(72) Inventors: Osama Abdel Latif Lotfallah, San Diego, CA (US); Carlos Marcelo Dias Pazos, Carlsbad, CA (US); Ralph Akram Gholmieh, San Diego, CA (US); Nagaraju Naik, San Diego, CA (US)

(21) Appl. No.: 15/184,539

(22) Filed: Jun. 16, 2016

Related U.S. Application Data
(60) Provisional application No. 62/185,425, filed on Jun. 26, 2015.

(51) Int. Cl. H04L 12/26; H04L 29/06; H04W 24/10; H04L 12/14

(52) U.S. Cl. CPC H04L 43/062; H04L 12/1432; H04L 65/4076; H04W 24/10; H04L 67/02

(57) ABSTRACT

An example client device for reporting consumption of media data includes one or more network interfaces configured to send and receive data via a network, and a middleware unit implemented from one or more hardware-based processors comprising digital logic circuitry, the middleware unit configured to determine a service area in which the client device was located when the client device received media data via the network interfaces, determine a reporting strategy for consumption of the media data based on the determined service area in which the client device was located when the client device received the media data, and report consumption of the media data according to the reporting strategy.

This application claims the benefit of U.S. Provisional Application No. 62/185,425, filed Jun. 26, 2015, the entire contents of which are hereby incorporated by reference.

### TECHNICAL FIELD

This disclosure relates to transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H. 263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, the techniques of this disclosure are directed to determining a reporting strategy for reporting consumption of media data. A media provider may be interested in knowing what media data is consumed in a variety of different areas. For example, the media provider may provide the media data in different areas using different services (e.g., broadcast, multicast, or unicast), based on a number of devices retrieving the media data. Thus, the media provider may request consumption reporting from the client devices, in order to activate or deactivate certain media delivery services in various areas. However, consumption reporting strategies may be defined differently for different areas. For example, the media provider may always provide broadcast/multicast for certain areas because it is expected that a large number of client devices will use the broadcast or multicast service, and therefore, consumption reporting may be overly burdensome. Alternatively, in some areas, the broadcast or multicast service may never be enabled, e.g., in areas where it is not expected that many client devices would access the media data.

In one example, a method of reporting consumption of media data includes, by a middleware unit of a client device: determining a service area in which the client device was located when the client device received media data, determining a reporting strategy for consumption of the media data based on the determined service area in which the client device was located when the client device received the media data, and reporting consumption of the media data according to the reporting strategy.

In another example, a client device for reporting consumption of media data includes one or more network interfaces configured to send and receive data via a network, and a middleware unit implemented from one or more hardware-based processors comprising digital logic circuitry, the middleware unit configured to determine a service area in which the client device was located when the client device received media data via the network interfaces, determine a reporting strategy for consumption of the media data based on the determined service area in which the client device was located when the client device received the media data, and report consumption of the media data according to the reporting strategy.

In another example, a device for reporting consumption of media data includes means for determining a service area in which the client device was located when the client device received media data, means for determining a reporting strategy for consumption of the media data based on the determined service area in which the client device was located when the client device received the media data, and means for reporting consumption of the media data according to the reporting strategy.

In another example, a computer-readable storage medium has stored thereon instructions that, when executed, cause a processor of a middleware unit of a client device to determine a service area in which the client device was located when the client device received media data, determine a reporting strategy for consumption of the media data based on the determined service area in which the client device was located when the client device received the media data, and report consumption of the media data according to the reporting strategy.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of the data reception unit of FIG. 1 in greater detail.

FIG. 3 is a conceptual diagram illustrating another example system in accordance with the techniques of this disclosure.

FIG. 4 is a conceptual diagram illustrating various service areas in which user equipment (UE) may be located when consuming media data.

FIG. 5 is a conceptual diagram illustrating an example set of data included in an associated delivery procedure description (ADPD).

FIG. 6 is a conceptual diagram illustrating an example set of data that may be included in an associated delivery procedure description (ADPD) in accordance with the techniques of this disclosure.

FIG. 7 is a conceptual diagram illustrating another example set of data that may be included in an ADPD in accordance with the techniques of this disclosure.

FIG. 8 is a flow diagram illustrating an example method for switching between unicast and broadcast by an enhanced multimedia broadcast multicast service (eMBMS) middleware unit and a broadcast multicast service center (BMSC), including consumption reporting in accordance with the techniques of this disclosure.

FIG. 9 is a flowchart illustrating an example method of transferring media data and reporting consumption of the media data in accordance with the techniques of this disclosure.

### DETAILED DESCRIPTION

In general, this disclosure describes techniques for reporting media consumption by a client device based on a service area in which the client device consumed the media data. The service area may be identified using a service area identifier (SAI). The client device may determine a reporting strategy based on the service area in which the client device is located, and report (or abstain from reporting) consumption of media data while in that service area according to the reporting strategy. For example, the reporting strategy may define any or all of a sampling percentage, a reporting interval, whether a client identifier (ID) is to be included in the report, and/or a location for the service area.

In some examples, the client device operates according to a default reporting strategy in general, but certain service areas are defined for which no consumption reports are to be submitted. In some examples, the client device operates according to a default reporting strategy in general, but certain service areas are defined for which one or more reporting characteristics are modified. For example, the client device may operate according to a default reporting strategy for most service areas including a default reporting interval, but another service area may have defined a different, custom reporting interval. Thus, while in that service area, the client device may deliver consumption reports according to the custom reporting interval.

The client device may receive an associated delivery procedure description (ADPD) data structure that defines the reporting strategies for various service areas. For example, the ADPD may define a general reporting strategy and one or more custom reporting strategies for various service areas. Additionally or alternatively, the ADPD may indicate one or more service areas for which consumption reports are not to be generated. The ADPD may be modified as discussed in greater detail below to include indications of reporting strategies based on service areas.

The techniques of this disclosure may thereby overcome certain deficiencies of conventional reporting techniques. In conventional techniques, the r12:consumptionReport is customized for using the same parameters across all service areas. However, this disclosure recognizes that content providers and network operators may need to set the value of reportInterval differently depending on service area. For example, for an in-venue service area, broadcast delivery may be permanently enabled, such that consumption reporting is unnecessary. That is, there may be no need for consumption reports, because the reports may be used to determine whether to enable or disable an eMBMS service based on a number of media consuming client devices. However, when the eMBMS service is always enabled, such reports may be unnecessary.

Additionally, in certain areas, such as a parking lot outside a venue service area, broadcast or multicast may be enabled based on demand. Thus, a small value for reportInterval value might be needed in such areas. Likewise, in some areas, broadcast delivery may rarely be enabled, e.g., in suburban service areas. Thus, a large value for reportInterval might be acceptable. The techniques of this disclosure may provide flexibility to customize the consumption reporting for MBMS operation on Demand (MooD) services differently for different service areas.

In general, the techniques of this disclosure may be performed by a broadcast or multicast reception unit of a client device. The broadcast or multicast reception unit may comprise, for example, an enhanced multimedia broadcast multicast service (eMBMS) unit, or a middleware unit configured to receive eMBMS data. Such a middleware unit may further include or control a server unit that acts as a server with respect to a streaming client, such as a dynamic adaptive streaming over HTTP (DASH) client that streams data from the server unit using HTTP streaming.

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more periods. Periods may be defined by a Period element in the MPD. Each period may have an attribute start in the MPD. The MPD may include a start attribute and an availableStartTime attribute for each period. For live services, the sum of the start attribute of the period and the MPD attribute availableStartTime may specify the availability time of the period in UTC format, in particular the first Media Segment of each representation in the corresponding period. For on-demand services, the start attribute of the first period may be 0. For any other period, the start attribute may specify a time offset between the start time of the corresponding Period relative to the start time of the first Period. Each period may extend until the start of the next Period, or until the end of the media presentation in the case of the last period. Period start times may be precise. They may reflect the actual timing resulting from playing the media of all prior periods.

Each period may contain one or more representations for the same media content. A representation may be one of a number of alternative encoded versions of audio or video data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

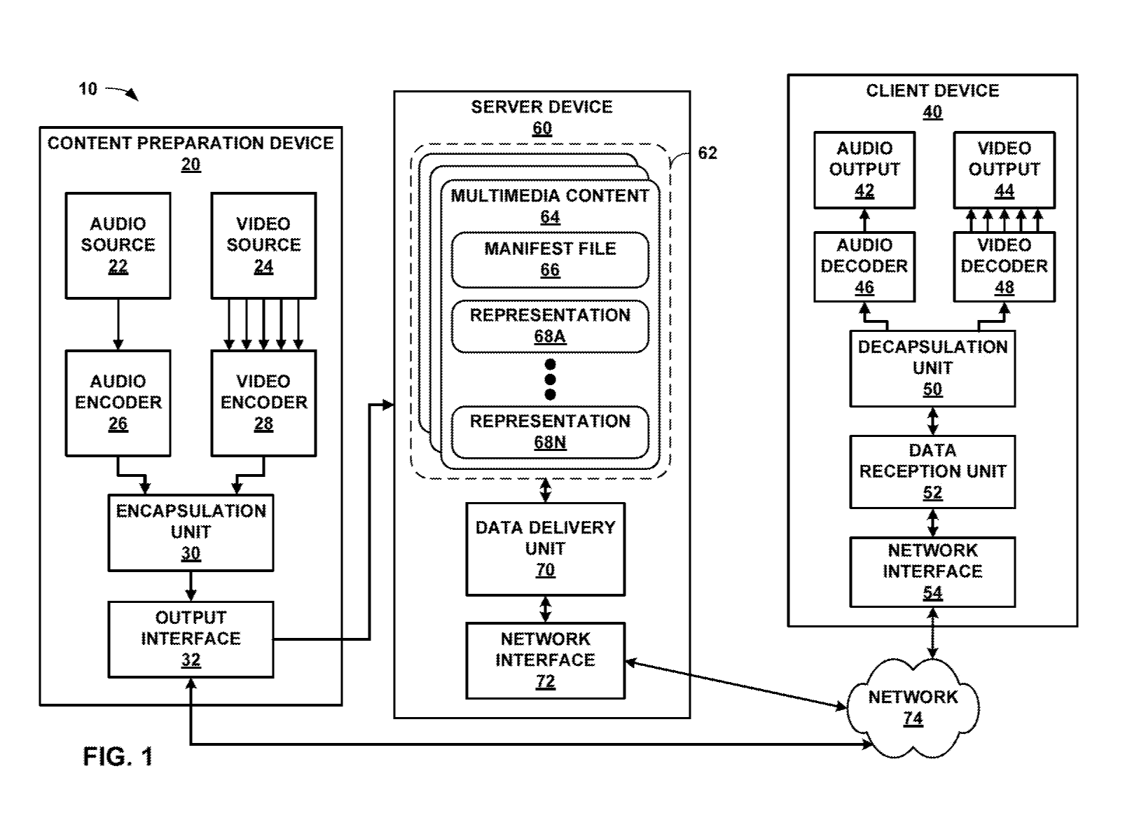

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. In the example of H.264/AVC (Advanced Video Coding), coded video segments are organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes data delivery unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Data delivery unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, data delivery unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

Data reception unit 52 may be configured to receive data in accordance with a broadcast or multicast network protocol, such as eMBMS or IP multicast. In such examples, data reception unit 52 may submit a request to join a multicast network group associated with particular media content. After joining the multicast group, data reception unit 52 may receive data of the multicast group without further requests issued to server device 60 or content preparation device 20. Data reception unit 52 may submit a request to leave the multicast group when data of the multicast group is no longer needed, e.g., to stop playback or to change channels to a different multicast group.

Network interface 54 may receive and provide data of segments of a selected representation to data reception unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, data reception unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, data reception unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, data reception unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via data reception unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Data reception unit 52 represents an example of a middleware unit of a client device configured to determine a service area in which the client device was located when the client device received media data via the network interfaces, determine a reporting strategy for consumption of the media data based on the determined service area in which the client device was located when the client device received the media data, and report consumption of the media data according to the reporting strategy, in accordance with the techniques of this disclosure.

In particular, data reception unit 52 may receive media data, e.g., according to broadcast, multicast, or unicast. For example, if an eMBMS service is available, data reception unit 52 may receive the media data via eMBMS, whereas if the eMBMS service is not available, data reception unit 52 may request the media data using unicast and receive the media data in response to the request (e.g., an HTTP GET or partial GET request).

Data reception unit 52 may further determine a service area in which client device 40 is positioned when the media data is received. For example, data reception unit 52 may determine a service area identifier (SAI) for the service area. Data reception unit 52 may further determine a reporting strategy to which the SAI is mapped, e.g., in an associated delivery procedure description (ADPD) data structure or a user service description (USD) data structure. The ADPD or USD may include a plurality of SAIs, each mapped to a respective reporting strategy (where multiple SAIs may be mapped to the same reporting strategy). The reporting strategy may include modifications to default values for reporting characteristics, an indication of whether or not to report in the corresponding area, a particular reporting strategy for the corresponding area, or the like. In some examples, the ADPD or USD may indicate that reporting is disabled in certain locations.

The reporting characteristics may include a reporting interval indicative of a frequency at which to send consumption reports. The reporting characteristics may also include a sampling percentage indicative of a probability for sending consumption reports for media data consumed in the service area. That is, at the expiration of each reporting interval, client device 40 (or more particularly, data reception unit 52 ) may determine whether a randomly selected value is within the sampling percentage value, and if so, send a consumption report (and if not, abstain from sending the consumption report). The consumption report may include an indication of the location in which media data was consumed and/or an identifier of client device 40, based on the reporting strategy.

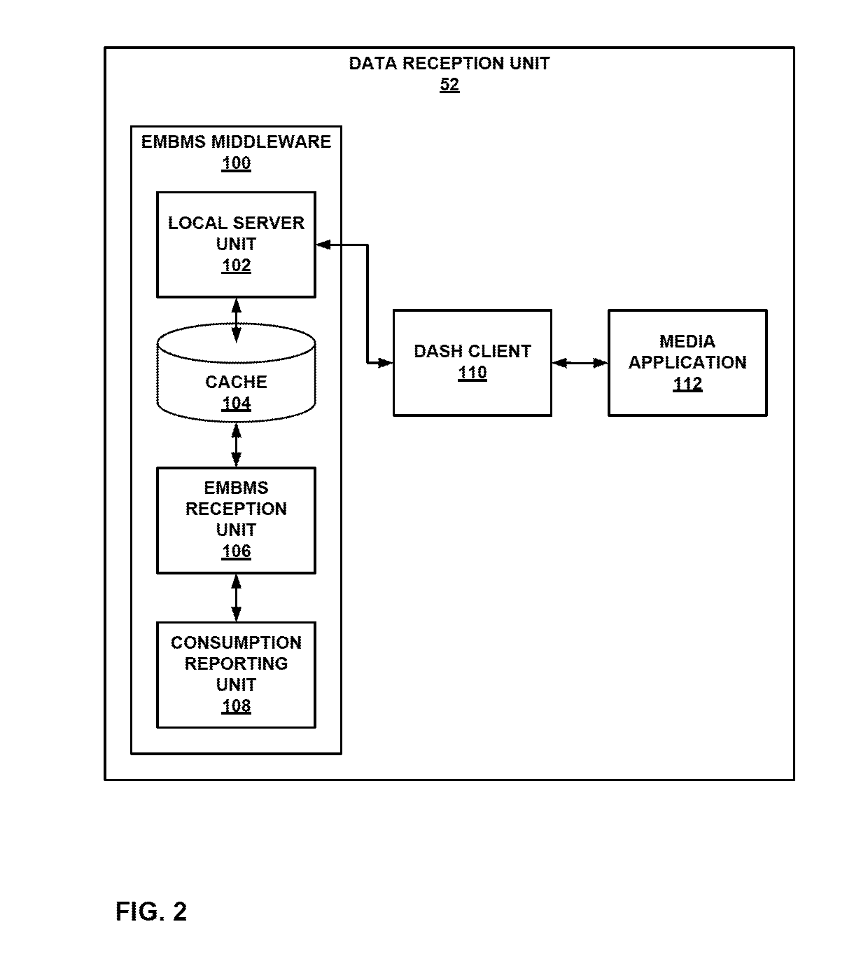

FIG. 2 is a block diagram illustrating an example set of components of data reception unit 52 of FIG. 1 in greater detail. In this example, data reception unit 52 includes eMBMS middleware unit 100, DASH client 110, and media application 112. The functionality attributed to eMBMS middleware unit 100, consumption reporting unit 108, local server unit 102, DASH client 110, and media application 112 may be implemented by any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof.

In this example, eMBMS middleware unit 100 further includes eMBMS reception unit 106, cache 104, local server unit 102, and consumption reporting unit 108. In this example, eMBMS reception unit 106 is configured to receive data via eMBMS, e.g., according to File Delivery over Unidirectional Transport (FLUTE), described in T. Paila et al., “FLUTE—File Delivery over Unidirectional Transport,” Network Working Group, RFC 6726, November 2012, available at http://tools.ietf.org/html/rfc6726. That is, eMBMS reception unit 106 may receive files via broadcast from, e.g., server device 60, which may act as a BM-SC.

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Local server unit 102 may act as a server for DASH client 110. For example, local server unit 102 may provide a MPD file or other manifest file to DASH client 110. Local server unit 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from local server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to local server unit 102. Local server unit 102 may retrieve requested data from cache 104 and provide the data to DASH client 110 in response to such requests.

Consumption reporting unit 108 generally reports consumption of media data in accordance with the techniques of this disclosure. For example, consumption reporting unit 108 may receive an ADPD (or USD) that defines reporting strategies that may vary by service area. In accordance with the techniques of this disclosure, consumption reporting unit 108 may report consumption of media data based on a service area in which client device 40 is present when the media data is consumed, according to the reporting strategy as defined in the ADPD (or USD).

In particular, consumption reporting unit 108 may receive media data, e.g., according to broadcast, multicast, or unicast. For example, if an eMBMS service is available, consumption reporting unit 108 may receive the media data via eMBMS, whereas if the eMBMS service is not available, consumption reporting unit 108 may request the media data using unicast and receive the media data in response to the request (e.g., an HTTP GET or partial GET request).

Consumption reporting unit 108 may further determine a service area in which client device 40 is positioned when the media data is received. For example, consumption reporting unit 108 may determine a service area identifier (SAI) for the service area. Consumption reporting unit 108 may determine the service area based on, e.g., global positioning system (GPS) data and/or based on which of a plurality of nearby base stations has a strongest signal (and/or the base station from which media data is received). Consumption reporting unit 108 may further determine a reporting strategy to which the SAI is mapped, e.g., in an associated delivery procedure description (ADPD) data structure or a user service description (USD) data structure. The ADPD or USD may include a plurality of SAIs, each mapped to a respective reporting strategy (where multiple SAIs may be mapped to the same reporting strategy). The reporting strategy may include modifications to default values for reporting characteristics, an indication of whether or not to report in the corresponding area, a particular reporting strategy for the corresponding area, or the like. In some examples, the ADPD or USD may indicate that reporting is disabled in certain locations.

The reporting characteristics may include a reporting interval indicative of a frequency at which to send consumption reports. The reporting characteristics may also include a sampling percentage indicative of a probability for sending consumption reports for media data consumed in the service area. That is, at the expiration of each reporting interval, client device 40 (or more particularly, consumption reporting unit 108) may determine whether a randomly selected value is within the sampling percentage value, and if so, send a consumption report (and if not, abstain from sending the consumption report). The consumption report may include an indication of the location in which media data was consumed and/or an identifier of client device 40, based on the reporting strategy.

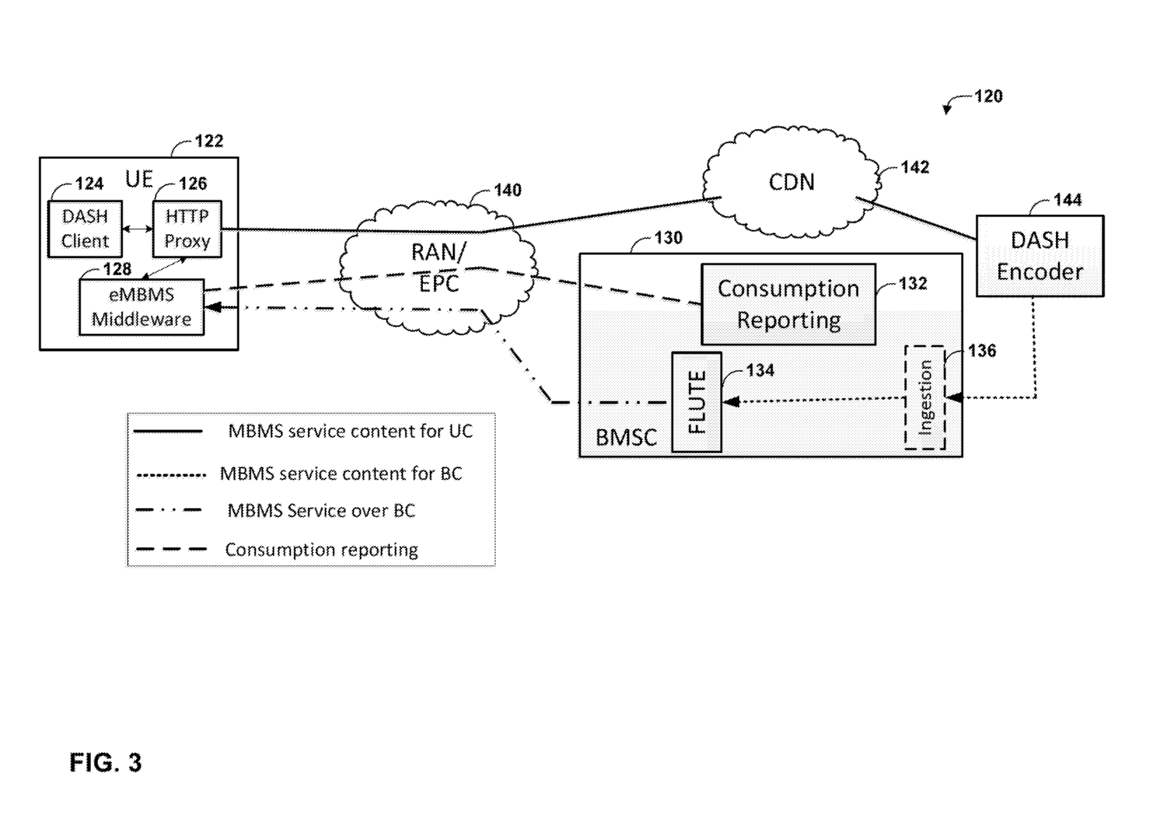

FIG. 3 is a conceptual diagram illustrating another example system 120 in accordance with the techniques of this disclosure. System 120 includes user equipment (UE) 122, radio area network (RAN)/evolved packet core (EPC) 140, content delivery network 142, DASH encoder 144, and broadcast multicast service center (BMSC) 130. UE 122 of FIG. 3 may correspond to client device 40 of FIG. 1, BMSC 130 of FIG. 3 may correspond to server device 60 of FIG. 1, and DASH encoder 144 of FIG. 3 may correspond to content preparation device 20 of FIG. 1 or a different server device.

In general, UE 122 includes DASH client 124, HTTP proxy 126, and eMBMS middleware unit 128. Any or all of these components may be implemented in hardware, software, firmware, or a combination thereof. When implemented in software or firmware, it should be understood that requisite hardware (such as memory for storing instructions of the software or firmware and one or more hardware-based processors) are also provided. In this manner, each of DASH client 124, HTTP proxy 126, and eMBMS middleware unit 128 may be implemented by one or more hardware-based processors comprising digital logic circuitry. Digital logic circuitry should be understood to represent fixed logic (such as an ASIC) or programmable logic (such as a microprocessor or an FPGA).

DASH client 124 of FIG. 3 may correspond to DASH client 110 of FIG. 2, HTTP proxy 126 of FIG. 3 may correspond to local server unit 102 of FIG. 2, and eMBMS middleware unit 128 of FIG. 3 may correspond to eMBMS middleware unit 100 of FIG. 2. In the example of FIG. 3, HTTP proxy 126 is shown separately from eMBMS middleware unit 128 for purposes of example, although it should be understood that HTTP proxy 126 may instead be included in eMBMS middleware unit 128, as shown in FIG. 2.

In general, UE 122 may receive media data through unicast (UC) or broadcast (BC). When a current service area in which UE 122 is located provides an eMBMS service, or other broadcast or multicast service, the UE may receive media data via the broadcast or multicast service. However, when in a service area that does not provide such a broadcast or multicast service, the UE may receive media data using unicast, e.g., DASH. UE 122 may retrieve media data using unicast via CDN 142 of FIG. 3. Although not shown in FIG. 3, CDN 142 should be understood to include, e.g., server devices, proxy server devices, network caching devices, or the like for receiving encoded media data from, e.g., DASH encoder 144, and for responding to requests, such as HTTP GET requests, from client devices, such as UE 122.

In general, DASH encoder 144 makes segments available via the CDN for unicast and via BMSC 130 for broadcast. DASH encoder 144 may, for example, receive encoded media data and prepare DASH segments for distribution to CDN 142 and BMSC 130. Each of the segments may correspond to an independently retrievable file. Thus, each of the segments may be associated with a distinct uniform resource locator (URL). Segments may generally include audio, video, or other media data (such as timed text). Video segments may include a respective plurality of distinct video frames (that is, distinct pictures), where the distinct video frames or pictures are generally to be presented at different times. Thus, one video segment may include video data for a time period of, e.g., two to ten seconds of playback.

HTTP proxy 126 may intercept HTTP GET or partial GET requests and direct them either to CDN 142 or to eMBMS middleware unit 128. In this manner, the DASH client need not be informed of whether DASH segments are delivered via unicast or broadcast. Alternatively, when eMBMS is active, DASH client 124 may send HTTP GET or partial GET requests to HTTP proxy 126, and when eMBMS is inactive, DASH client 124 may send HTTP GET or partial GET requests to CDN 142. For example, eMBMS middleware unit 128 may modify an MPD for a media service to indicate a localhost URL associated with UE 122 when eMBMS is active, to cause HTTP GET or partial GET requests to be directed to HTTP proxy 126, whereas when eMBMS is inactive, DASH client 124 may submit HTTP GET or partial GET requests to URLs as advertised in the MPD without modification (which will direct the requests to CDN 142).

The BMSC also includes consumption reporting unit 132, which may receive consumption reports from UEs. Thus, UE 122 may send consumption reports to the BMSC, which may act as a reporting server. Alternatively, a separate reporting server may be defined. In general, UE 122 may send reports of service starts, service stops, and/or periodic reports during service consumption, e.g., according to an ADPD for the service, based on the service area in which UE 122 is located (e.g., geographically positioned).

BMSC 130 may count a number of UEs consuming DASH content via unicast when broadcast is not available. If this number is less than a threshold, BMSC 130 may disable broadcast (e.g., eMBMS or MBMS), such that data is only available via unicast, whereas if the number exceeds the threshold, the BMSC may enable broadcast (e.g., eMBMS or MBMS) delivery. Likewise, if the number drops below the threshold, BMSC 130 may disable broadcast delivery.

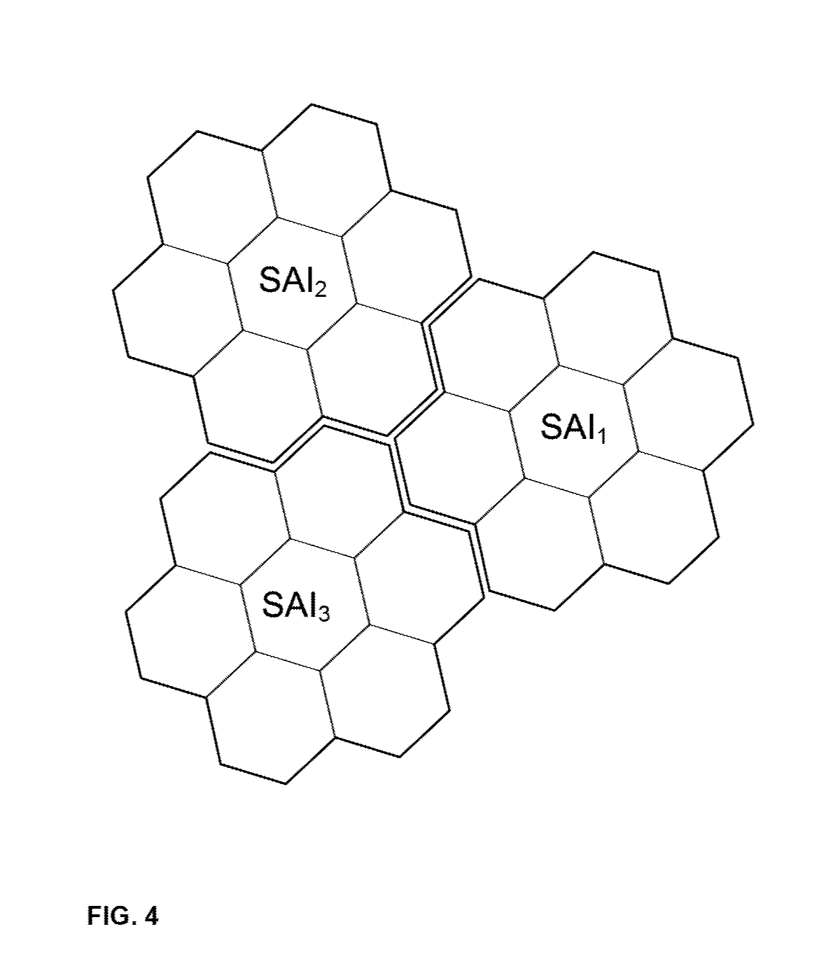

FIG. 4 is a conceptual diagram illustrating various service areas in which a UE may be located when consuming media data. As noted above, an ADPD, or other data structure (such as a USD), may be used to define per-service-area consumption reporting strategies. In one example, a reporting interval (reportInterval) value may be defined in the ADPD that indicates how frequently the eMBMS middleware is to report (or determine whether to report, according to a probabilistic determination) consumption of media data. For example, the ADPD may include the following information:

<consumptionReport samplePercentage=“100”
reportInterval=“PT10M” ... >

<serviceURI>Svc1</serviceURI>
<location>MBMS SAI</location>

</consumptionReport>

In this example, reportInterval has a value of “PT10M,” which indicates that consumption reports are sent every ten minutes. The ADPD or USD may further include data indicating to which service areas the reporting interval applies. For example, assuming that SAI₁ of FIG. 4 is defined as area “123,” SAI₂ of FIG. 4 is defined as area “456,” and SAI₃ of FIG. 4 is defined as area “789,” the following data may be included in the ADPD or USD to indicate that the reporting interval defined above applies to SAI₁, SAI₂, and SAI₃:

<availabilityInfo>

<infoBinding>

<serviceArea>123</serviceArea>
<serviceArea>456</serviceArea>
<serviceArea>789</serviceArea>
<radioFrequency>9876</radioFrequency>

</infoBinding>

</availabilityInfo>

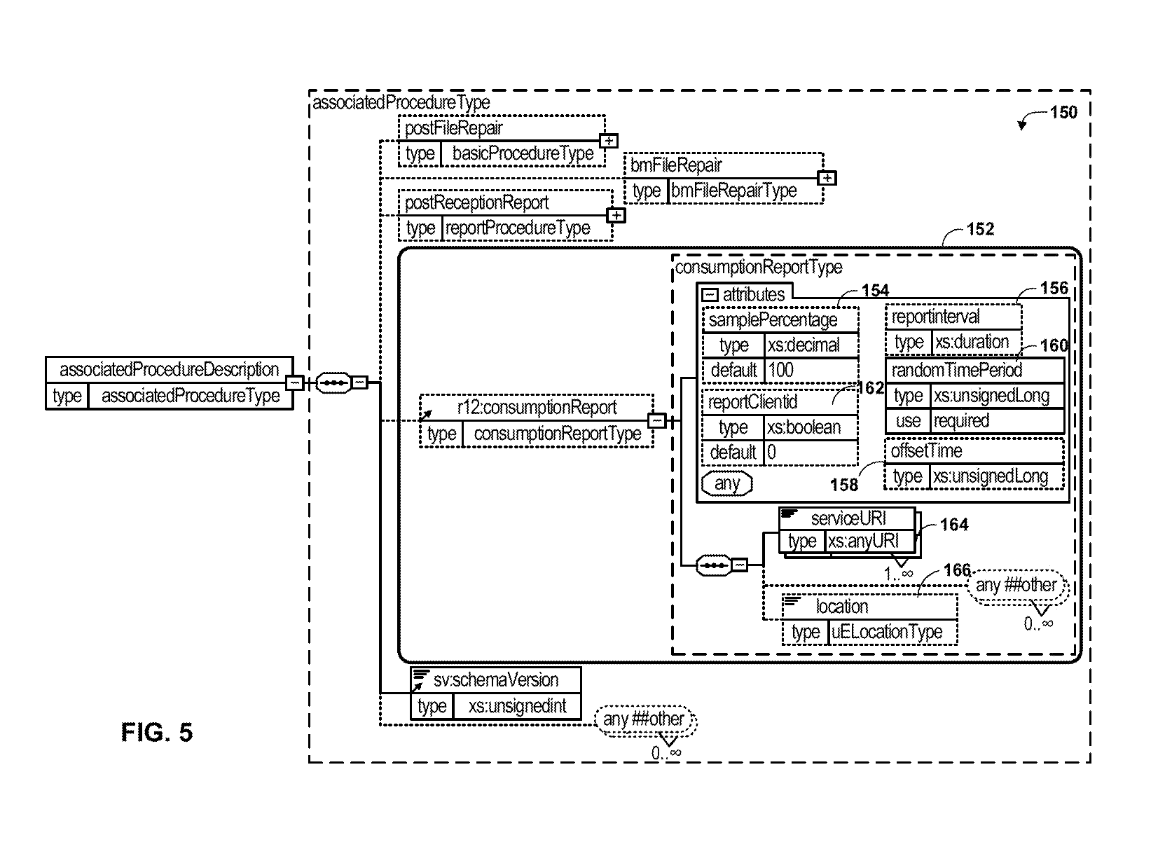

FIG. 5 is a conceptual diagram illustrating an example set of data included in an ADPD. A conventional ADPD signals requirements for MBMS user service consumption reporting by a UE. With respect to consumption reporting, the ADPD may indicate, for example:
samplePercentage: subset to perform reporting (=100)
reportInterval: frequency for the UE to report
reportClientID: whether UE includes ClientID in report
Location: whether UE includes its location (CGI, ECGI, MBMS SAI) in report
offsetTime & randomTimePeriod: small value
serviceURI: same for multiple BM-SC

In accordance with the techniques of this disclosure, however, any or all of these values may be customized on a per-service-area basis. That is, the ADPD may be modified to define a custom reporting strategy for any or all service areas. For example, consumption reporting element 152 of FIG. 5 represents attributes including, for example, sample percentage 154, report interval 156, offset time 158, random time period 160, and report client ID 162. Such attributes may be signaled per service URI, as indicated by service URIs 164. Furthermore, the UE (e.g., UE 122 or client device 40) may be configured to send consumption reports based on a service area in which the UE consumes media data, as indicated by location element 166 of the modified ADPD, according to the techniques of this disclosure. Additionally or alternatively, a USD may include this or similar data.

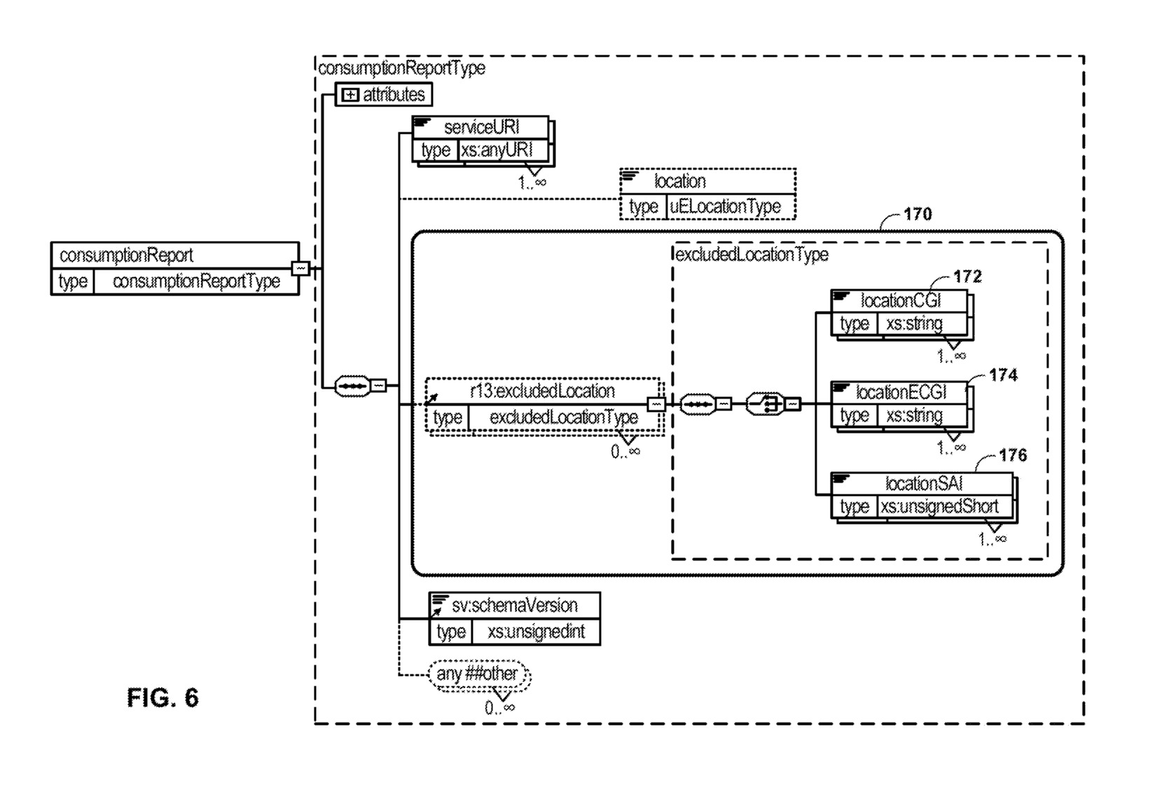

FIG. 6 is a conceptual diagram illustrating an example set of data that may be included in an ADPD in accordance with the techniques of this disclosure. In accordance with these techniques, the r 12: consumptionReport may be extended to signal the requirement for excluding certain MBMS location(s) from sending consumption reporting by the UE. In the example of FIG. 6, the r13:excludedLocation element 170 is used for this purpose. Location may be specified by any or all of locationCGI element 172, locationECGI element 174, or locationSAI element 176. LocationCGI element 172 expresses a location in terms of a Cell Global Identification (CGI), locationECGI element 174 expresses a location in terms of E-UTRAN Cell Global Identification (ECGI), and locationSAI element 176 expresses a location in terms of a service area identifier (SAI).

Referring back to the example of FIG. 4, the following data may be used to exclude certain service areas from consumption reporting. Again, assuming that SAI₁ is defined as area “123,” SAI₂ is defined as area “456,” and SAI₃ is defined as area “789,” the following data may be included in the ADPD to indicate that the reporting interval applies to SAI₃, but that SAI₁ and SAI₂, are excluded from the reporting interval:

<consumptionReport samplePercentage=“100”
reportInterval=“PT10M” ... >

<serviceURI>Svc1</serviceURI>
<location>MBMS SAI</location>
<r13:excludedLocation>

<r13:locationSAI>123</r13:locationSAI>
<r13:locationSAI>456</r13:locationSAI>

</r13:excludedLocation>
<sv:schemaVersion>0</sv:schemaVersion>

</consumptionReport>
<availabilityInfo>

<infoBinding>

<serviceArea>123</serviceArea>
<serviceArea>456</serviceArea>
<serviceArea>789</serviceArea>
<radioFrequency>9876</radioFrequency>

</infoBinding>

</availabilityInfo>

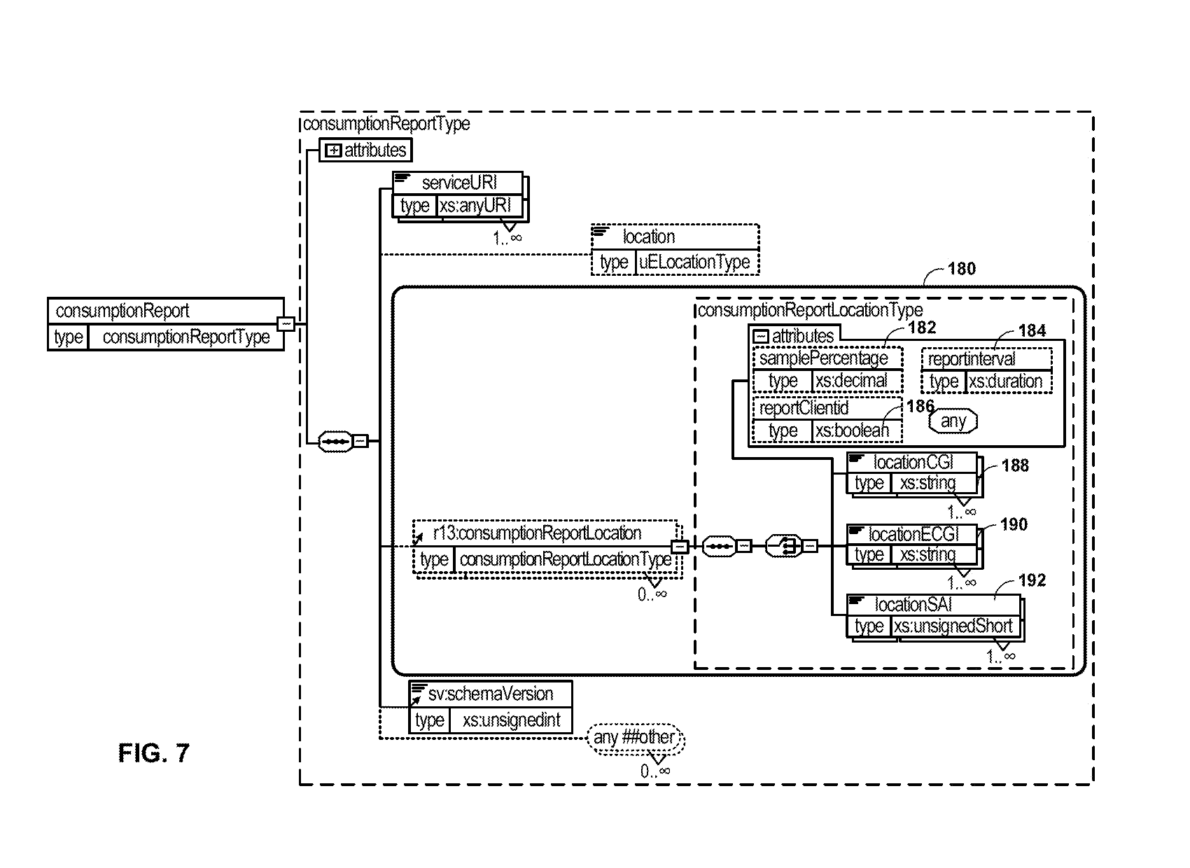

FIG. 7 is a conceptual diagram illustrating another example set of data that may be included in an ADPD in accordance with the techniques of this disclosure. FIG. 7 represents an example in which the r 12: consumptionReport is extended to signal requirements for per-location MBMS user service consumption reporting by UEs, e.g., using consumption report location element 180. The data shown in FIG. 7 may be used to override default data that generally applies to other service areas, and any or all of the values may be specified for a given service area.

The data of FIG. 7 includes the following:
samplePercentage 182: subset to perform reporting (=100)
   This value overrides the r12:consumptionReport.sampelPercentage for the specific location expressed by locationCGI element 188, locationECGI element 190, or locationSAI element 192.
reportInterval 184: frequency for the UE to report
   This value overrides the r12:consumptionReportreportInterval for the specific location expressed by locationCGI element 188, locationECGI element 190, or locationSAI element 192.
reportClientID 186: whether UE includes ClientID in report
   This value overrides the r12:consumptionReport.reportClientID for the specific location expressed by locationCGI element 188, locationECGI element 190, or locationSAI element 192.
Location is specified by either locationCGI element 188, locationECGI element 190, or locationSAI element 192.

Referring again to the example of FIG. 4, SAI₁ is defined as area “123,” SAI₂ is defined as area “456,” and SAI₃ is defined as area “789,” the following data may be included in the ADPD to specify that SAI₁ has a reporting interval of PT5M, SAI₂ has consumption reporting disabled since reporting interval=PT0M, and SAI₃ uses the default PT10M reporting interval:

<consumptionReport samplePercentage=″100″
reportInterval=″PT10M″ ... >

<serviceURI>Svc1</serviceURI>
<location>MBMS SAI</location>
<r13:consumptionReportLocation reportInterval=″PT5M” ..>

<r13:locationSAI>123</r13:locationSAI>

</r13:consumptionReportLocation>
<r13:consumptionReportLocation reportInterval=″PT0M” ..>

<r13:locationSAI>456</r13:locationSAI>

</r13:consumptionReportLocation>
<sv:schemaVersion>0</sv:schemaVersion>

</consumptionReport>
<availabilityInfo>

<infoBinding>

<serviceArea>123</serviceArea>
<serviceArea>456</serviceArea>
<serviceArea>789</serviceArea>
<radioFrequency>9876</radioFrequency>

</infoBinding>

</availabilityInfo>

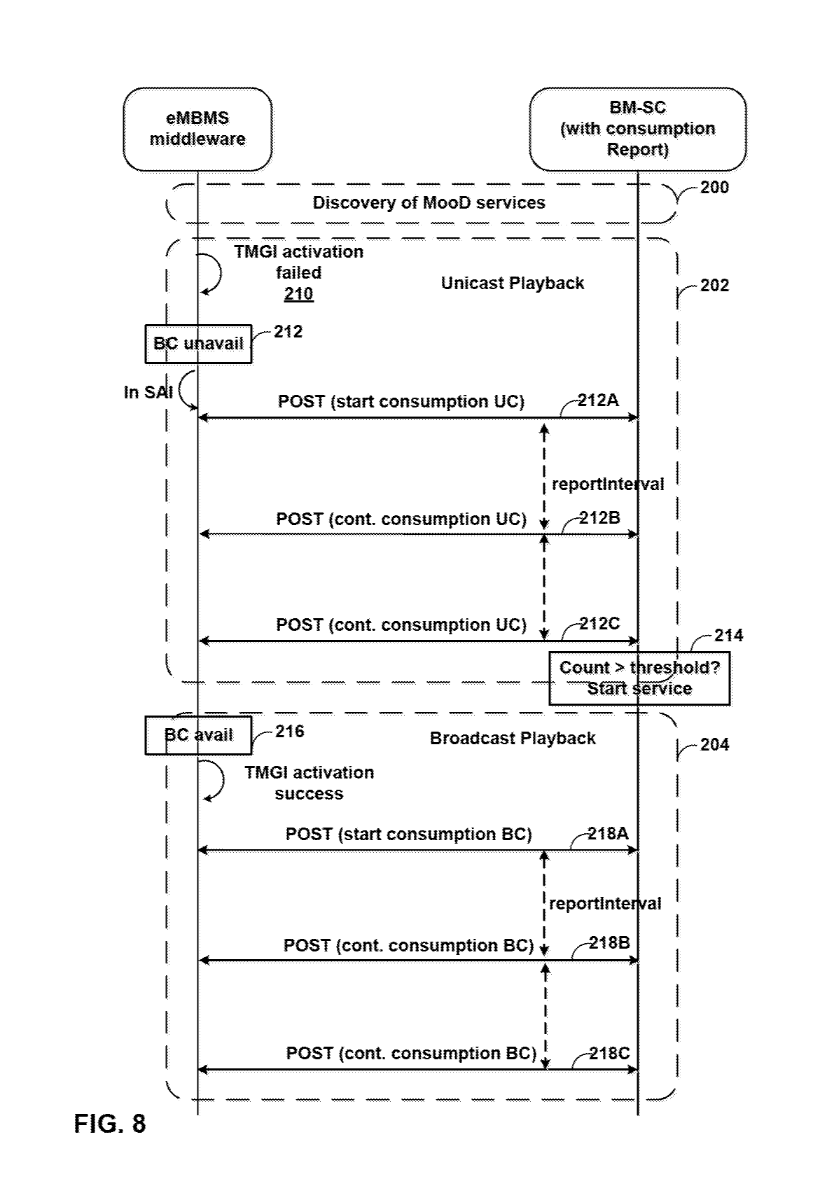

FIG. 8 is a flow diagram illustrating an example method for switching between unicast and broadcast by an eMBMS middleware unit and a BMSC, including consumption reporting in accordance with the techniques of this disclosure. The techniques of FIG. 8 may be performed by, e.g., client device 40 (representing an example of UE) and server device 60 (representing an example BMSC) (FIG. 1) or UE 122 and BMSC 130 of FIG. 3.

Initially, the BMSC may advertise MBMS operation on Demand (MooD) services within various service areas, and the eMBMS middleware unit may discover available services from this advertisement (200). The eMBMS middleware unit may attempt to discover a temporary mobile group identity (TMGI), and when this fails (210), determine that broadcast is unavailable. The BMSC may deactivate broadcast service for a set of media data when a number of UEs consuming the media data is below a threshold, such that the eMBMS middleware (or the UEs generally) determine that broadcast is unavailable (212) and therefore perform unicast playback (202).

Assuming that the UE consumes media data using unicast, the UE may receive the media data using unicast and report consumption of the media data (212A-212C). For example, the UE may use HTTP POST commands to report consumption of the media data. In particular, the eMBMS middleware unit may use the POST method to send consumption report messages to the BMSC at periodic intervals, in addition to start/stop of BC/UC access related events. The periodic intervals may be defined according to a reporting interval element of the ADPD or USD as part of the reporting strategy associated with the service area in which the UE is located.

In particular, during unicast consumption of the MooD service, the eMBMS may send consumption reports only if the UE is in infoBinding.serviceArea in user service description (USD) describing the service.

If at some point the BMSC determines that the number of UEs consuming the media data exceeds the threshold (214), the BMSC may enable the broadcast service (e.g., eMBMS) to deliver the media data via broadcast or multicast to the consuming UEs (204). That is, the eMBMS middleware unit may determine that broadcast is available (216). In response, the eMBMS middleware unit may successfully activate TMGI and report consumption of the media content via broadcast or multicast.

Thus, when the UE detect the availability of broadcast delivery, the eMBMS middleware unit activates the TMGI and may send consumption reports (218A-218C) (e.g., always or based on data of an ADPD).

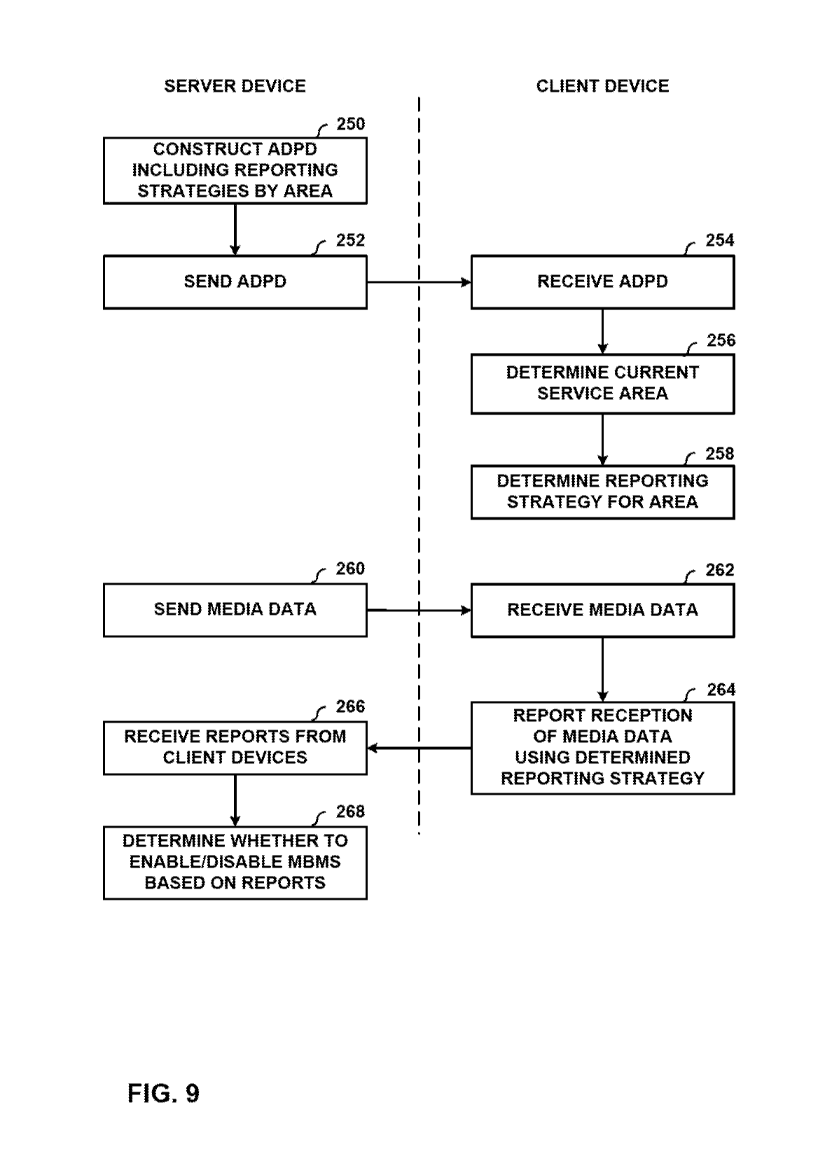

FIG. 9 is a flowchart illustrating an example method of transferring media data and reporting consumption of the media data in accordance with the techniques of this disclosure. For purposes of example and explanation, the method of FIG. 9 is explained with respect to the devices of FIG. 1, e.g., server device 60 and client device 40. However, it should be understood that other devices may be configured to perform this or a similar method. For example, UE 122 and BMSC 130 of FIG. 3 may be configured to perform this or a similar method.

Initially, server device 60 constructs an ADPD including data indicative of one or more reporting strategies by service area (250). For example, server device 60 may construct an ADPD resembling the ADPD of any of FIGS. 5-7. That is, the ADPD may include data indicating, for example, specific reporting strategies by service area, service areas in which reporting is excluded (e.g., as shown in FIG. 6), and/or a default reporting strategy that is revised based on service area (e.g., as shown in FIG. 7). Server device 60 then sends the ADPD to client device 40 (252). For example, server device 60 may send the ADPD in accordance with MBMS or eMBMS. The ADPD may be sent via a different bearer channel than media data, such as audio and video data.

Client device 40 may then receive the ADPD (254). Of course, client device 40 represents one of a potentially large number of client devices that receive the ADPD. Client device 40 (like other client devices) determines a current service area in which client device 40 is positioned (256). More particularly, consumption reporting unit 108 of eMBMS middleware unit 100 (FIG. 2) of data reception unit 52 of client device 40 may determine the current service area.

Specifically, consumption reporting unit 108 may determine a service area identifier (SAI) for the current service area in which client device 40 is geographically positioned. For example, consumption reporting unit 108 may determine the geographical position of client device 40 by interacting with a global positioning system (GPS) unit (not shown) of client device 40. Alternatively, consumption reporting unit 108 may determine the service area in which client device 40 is positioned based on which of a plurality of nearby base stations has a strongest signal, and determining that client device 40 is positioned in the service area including the base station having the strongest signal. Based on the current service area, consumption reporting unit 108 may determine a reporting strategy for the current service area (258) from the ADPD. For example, consumption reporting unit 108 may determine one or more reporting characteristics to which the SAI for the current service area is mapped in the ADPD.

The ADPD may represent only a single service area. Alternatively, the ADPD may represent a plurality of service areas. Thus, the ADPD may include a plurality of SAIs, each mapped to one of a plurality of reporting strategies. The number of reporting strategies need not necessarily be the same as the number of SAIs included in the ADPD. Client device 40 may determine the SAI included in the ADPD that matches the SAI for the service area in which client device 40 is located (that is, geographically positioned), and then determine the reporting strategy to which the SAI of the ADPD is mapped.

The reporting strategies described in the ADPD may include any or all of a sampling percentage value indicative of a probability for sending consumption reports for media data consumed in the service area, a reporting interval indicative of a frequency at which to send the consumption reports, a client identifier (ID) reporting value indicative of whether to include a client ID in the consumption reports, and/or a location reporting value indicative of a location for the service area. In some examples, the ADPD may define default values for any or all of these elements, which may be overridden by the reporting strategy for the service area in which client device 40 is located based on SAI-specific values defined in the ADPD.

Furthermore, server device 60 sends media data to client device 40 (260). Server device 60 may send the media data to client device 40 via broadcast or multicast, e.g., eMBMS, or via unicast. In general, server device 60 sends the media data via eMBMS when client device 40 is in a service area in which eMBMS is available and active. Server device 60 may use the consumption reports to determine whether to activate eMBMS, as discussed below. If eMBMS is not active, client device 40 may initially request the media data via unicast (e.g., by submitting an HTTP GET or partial GET request to server device 60).

In any case, client device 40 may receive the media data (262), e.g., via unicast in response to a unicast request or via broadcast or multicast. Client device 40 may further report reception of the media data using the determined reporting strategy (264). As discussed above, the reporting strategy may dictate criteria such as how frequently to send a report (that is, a reporting interval), a probability of sending the report at a given reporting time, whether a client ID is included in the report, or the like. It is assumed in this example that client device 40 is in the service area determined at step 256 above when the media data is received. However, it should be understood that additional determinations of the current service area may be made, e.g., when media data is obtained, when a new reporting interval has expired and a determination is to be made as to whether to report consumption of the media data, or the like.

Server device 60 receives the report from client device 40 (266), as well as from other client devices. Server device 60 then determines whether to enable or disable MBMS (or eMBMS, or other broadcast or multicast services) based on the reports from the client devices (268). For example, server device 60 may be configured with a threshold value. If the number of client devices consuming media data of a particular set of media content is above the threshold, server device 60 may activate MBMS/eMBMS (or leave MBMS/eMBMS active), whereas if the number of client devices consuming the media data is below the threshold, server device 60 may deactivate MBMS/eMBMS (or leave MBMS/eMBMS deactivated).

Although the method of FIG. 9 describes the use of an ADPD, it should be understood that other data structures may be used to convey the reporting strategy information attributed to the ADPD above. For example, instead of an ADPD, a user service description (USD) may be used to advertise reporting strategy information based on service areas in which client devices can be located, in order to dictate how consumption reports are to be delivered on a per-service-area basis.

In this manner, the method of FIG. 9 represents an example of a method of reporting consumption of media data, including determining a service area in which the client device was located when the client device received media data, determining a reporting strategy for consumption of the media data based on the determined service area in which the client device was located when the client device received the media data, and reporting consumption of the media data according to the reporting strategy.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of reporting consumption of media data, the method comprising:
by a middleware unit of a client device:
determining a service area in which the client device was located when the client device received media data;
determining a reporting strategy for consumption of the media data based on the determined service area in which the client device was located when the client device received the media data; and
reporting consumption of the media data according to the reporting strategy.

2. The method of claim 1, wherein determining the reporting strategy comprises:
obtaining a plurality of service area identifiers (SAIs), each SAI of the plurality of SAIs mapped to one of a plurality of reporting strategies; and
determining the reporting strategy for consumption of the media data as a reporting strategy of the plurality of reporting strategies to which an SAI for the determined service area is mapped.

3. The method of claim 1, wherein the reporting strategy defines one or more values comprising one or more of:
a sampling percentage indicative of a probability for sending consumption reports for media data consumed in the service area;
a reporting interval indicative of a frequency at which to send the consumption reports;
a client identifier (ID) reporting value indicative of whether to include a client ID in the consumption reports; or a location reporting value indicative of a location for the service area.

4. The method of claim 3, further comprising receiving one or more default values for one or more of a sampling percentage, a reporting interval, a client ID reporting value, or a location reporting value, wherein determining the reporting strategy comprises overriding at least one of the one or more default values with at least one of the one or more defined values of the reporting strategy.

5. The method of claim 1, wherein determining the reporting strategy comprises analyzing at least one of an associated delivery procedure description (ADPD) data structure or a user service description (USD) including data defining the reporting strategy.

6. The method of claim 5, wherein the ADPD or the USD includes an excluded location element representative of a service area for which consumption reporting is disabled.

7. The method of claim 5, wherein the ADPD or the USD includes a consumption report location element defining the reporting strategy for the service area.

8. The method of claim 7, wherein the consumption report location element includes a samplePercentage element, a reportInterval element, a reportClientID element, and one or more of a locationCGI element, a locationECGI element, or a locationSAI element.

9. The method of claim 1, further comprising receiving the media data in the service area, wherein reporting consumption of the media data comprises reception of the media data in the service area according to the reporting strategy.

10. A client device for reporting consumption of media data, the device comprising:
one or more network interfaces configured to send and receive data via a network; and
a middleware unit implemented from one or more hardware-based processors comprising digital logic circuitry, the middleware unit configured to:
determine a service area in which the client device was located when the client device received media data via the network interfaces;
determine a reporting strategy for consumption of the media data based on the determined service area in which the client device was located when the client device received the media data; and
report consumption of the media data according to the reporting strategy.

11. The device of claim 10, wherein to determine the reporting strategy, the middleware unit is configured to:
obtain a plurality of service area identifiers (SAIs), each SAI of the plurality of SAIs mapped to one of a plurality of reporting strategies; and
determine the reporting strategy for consumption of the media data as a reporting strategy of the plurality of reporting strategies to which an SAI for the determined service area is mapped.

12. The device of claim 10, wherein the reporting strategy defines one or more values comprising one or more of:
a sampling percentage indicative of a probability for sending consumption reports for media data consumed in the service area;
a reporting interval indicative of a frequency at which to send the consumption reports;
a client identifier (ID) reporting value indicative of whether to include a client ID in the consumption reports; or
a location reporting value indicative of a location for the service area.

13. The device of claim 10, wherein the middleware unit is configured to analyze at least one of an associated delivery procedure description (ADPD) data structure or a user service description (USD) to determine the reporting strategy.

14. The device of claim 13, wherein the ADPD or the USD includes a consumption report location element defining the reporting strategy for the service area.

15. The device of claim 14, wherein the consumption report location element includes a samplePercentage element, a reportInterval element, a reportClientID element, and one or more of a locationCGI element, a locationECGI element, or a locationSAI element.

16. The device of claim 10, wherein the device comprises at least one of:
an integrated circuit;
a microprocessor;
a wireless communication device.

17. A device for reporting consumption of media data, the device comprising:
means for determining a service area in which the client device was located when the client device received media data;
means for determining a reporting strategy for consumption of the media data based on the determined service area in which the client device was located when the client device received the media data; and
means for reporting consumption of the media data according to the reporting strategy.

18. The device of claim 17, wherein the means for determining the reporting strategy comprises:
means for obtaining a plurality of service area identifiers (SAIs), each SAI of the plurality of SAIs mapped to one of a plurality of reporting strategies; and
means for determining the reporting strategy for consumption of the media data as a reporting strategy of the plurality of reporting strategies to which an SAI for the determined service area is mapped.

19. The device of claim 17, wherein the reporting strategy defines one or more values comprising one or more of:
a sampling percentage indicative of a probability for sending consumption reports for media data consumed in the service area;
a reporting interval indicative of a frequency at which to send the consumption reports;
a client identifier (ID) reporting value indicative of whether to include a client ID in the consumption reports; or
a location reporting value indicative of a location for the service area.

20. The device of claim 17, wherein the means for determining the reporting strategy comprise means for analyzing at least one of an associated delivery procedure description (ADPD) data structure or a user service description (USD) to determine the reporting strategy.

21. The device of claim 20, wherein the ADPD or the USD includes a consumption report location element defining the reporting strategy for the service area.

22. The device of claim 21, wherein the consumption report location element includes a samplePercentage element, a reportInterval element, a reportClientID element, and one or more of a locationCGI element, a locationECGI element, or a locationSAI element.

23. A computer-readable storage medium having stored thereon instructions that, when executed, cause a processor of a middleware unit of a client device to:
determine a service area in which the client device was located when the client device received media data;
determine a reporting strategy for consumption of the media data based on the determined service area in which the client device was located when the client device received the media data; and
report consumption of the media data according to the reporting strategy.

24. The computer-readable storage medium of claim 23, wherein to determine the reporting strategy, the middleware unit is configured to:
obtain a plurality of service area identifiers (SAIs), each SAI of the plurality of SAIs mapped to one of a plurality of reporting strategies; and
determine the reporting strategy for consumption of the media data as a reporting strategy of the plurality of reporting strategies to which an SAI for the determined service area is mapped.

25. The computer-readable storage medium of claim 23, wherein the reporting strategy defines one or more values comprising one or more of:
a sampling percentage indicative of a probability for sending consumption reports for media data consumed in the service area;
a reporting interval indicative of a frequency at which to send the consumption reports;
a client identifier (ID) reporting value indicative of whether to include a client ID in the consumption reports; or
a location reporting value indicative of a location for the service area.

26. The computer-readable storage medium of claim 23, wherein the middleware unit is configured to analyze at least one of an associated delivery procedure description (ADPD) data structure or a user service description (USD) to determine the reporting strategy.

27. The computer-readable storage medium of claim 26, wherein the ADPD or the USD includes a consumption report location element defining the reporting strategy for the service area.

28. The computer-readable storage medium of claim 27, wherein the consumption report location element includes a samplePercentage element, a reportInterval element, a reportClientID element, and one or more of a locationCGI element, a locationECGI element, or a locationSAI element.
